(19) United States
(12) Patent Application Publication
(10) Pub. No.: US 2024/0104895 A1
(43) Pub. Date: Mar. 28, 2024

(54) DATA SELECTION

(71) Applicant: Apple Inc., Cupertino, CA (US)

(72) Inventors: Fernando A. MUJICA, Los Altos, CA (US); Vijay SRIVATSAN, Los Altos, CA (US); Muhammad Umair SIDDIQUE, Kanata (CA)

(21) Appl. No.: 18/213,666

(22) Filed: Jun. 23, 2023

Related U.S. Application Data
(60) Provisional application No. 63/409,641, filed on Sep. 23, 2022.

(51) Int. Cl. G06V 10/764; G06V 10/80

(52) U.S. Cl. CPC G06V 10/764; G06V 10/803; G06V 10/811

(57) ABSTRACT

The present disclosure generally relates select data (e.g., sensor data and/or depth values generated using sensor data). In some examples, techniques for determining whether to use sensor fusion are provided. In some examples, techniques for determining whether to use a voting mechanism are provided. In some examples, techniques for responding to different types of decisions are provided.

### CROSS-REFERENCE TO RELATED APPLICATIONS

The present application claims priority to U.S. Provisional Patent Application Ser. No. 63/409,641, entitled “DATA SELECTION,” filed on Sep. 23, 2022, which is hereby incorporated by reference in its entirety for all purposes.

### BACKGROUND

Compute systems (e.g., and electronic devices) often use sensor data to make decisions (e.g., identifying objects, calculating depth values, and performing certain operations instead of others) while operating in a physical environment. Such decisions rely on data being accurate. Accordingly, there is a need for techniques to select accurate data.

### SUMMARY

Current techniques for selecting data are generally ineffective and/or inefficient for operating in a physical environment, particularly when operating in real-time. This disclosure provides more effective and/or efficient techniques for selecting data. For example, one technique determines whether to fuse different data together or use a voting mechanism to select between data. Another technique determines whether a current context warrants selecting between incongruent data. Such techniques optionally complement or replace other methods for selecting data.

The disclosure herein often describes using examples of selecting between different depth values to determine a depth value of an object in a physical environment. It should be understood that other types of decisions can use the techniques described herein. In some examples, a technique can select between different temperature measurements using one or more thermometers to determine whether to activate a heating element. In such examples, the different measurement can be selected using a voting mechanism.

### DESCRIPTION OF THE FIGURES

For a better understanding of the various described embodiments, reference should be made to the Description of Figures below in conjunction with the following drawings, where like reference numerals refer to corresponding parts throughout the figures.

FIG. 1 is a block diagram illustrating a compute system.

FIG. 2 is a block diagram illustrating a device with interconnected subsystems.

FIG. 3 is a block diagram illustrating a device.

FIG. 4 is a block diagram illustrating a technique for using sensor data while a device is operating in the physical environment.

FIG. 5 is a block diagram illustrating a technique for determining whether to use a voting mechanism.

FIG. 6 is a flow diagram illustrating a method for determining whether to use sensor fusion.

FIG. 7 is a flow diagram illustrating a method for determining whether to use a voting mechanism.

FIG. 8 is a flow diagram illustrating a method for responding to different types of decisions.

### DETAILED DESCRIPTION

The following description sets forth exemplary techniques, methods, parameters, systems, computer readable storage medium, and the like. It should be recognized, however, that such description is not intended as a limitation on the scope of the present disclosure. Instead, such description is provided as a description of exemplary embodiments.

Methods described herein can include one or more steps that are contingent upon one or more conditions being met. It should be understood that the steps of these methods can be repeated multiple times, such that all of the one or more conditions upon which the one or more steps are contingent can be satisfied in different repetitions of the method. For example, if a method requires performing a first step upon a determination that a condition is satisfied and a second step upon a determination that the condition is not satisfied, a person of ordinary skill in the art would appreciate that the steps of the method are repeated until the condition, in no particular order, has been satisfied (e.g., in one set of repetitions of the method) and not satisfied (e.g., in another set of repetitions of the method). Thus, a method described with steps that are contingent upon one or more conditions being satisfied could be rewritten as a method that is repeated until each of the conditions described in the method has been satisfied. This, however, is not required of system or computer readable medium claims where the system or computer readable medium claims contain instructions for performing one or more steps that are contingent upon one or more conditions being satisfied. Because the instructions for the system or computer readable medium claims are stored in one or more processors and/or at one or more memory locations, the system or computer readable medium claims contain logic that can determine whether or not the condition has been satisfied without explicitly repeating steps of a method until all of the conditions (upon which steps in the method are contingent) have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first device could be termed a second device, and similarly, a second device could be termed a first device, without departing from the scope of the various described examples. In some examples, the first device and the second device are two separate references to the same device. In some examples, the first device and the second device are both devices, but they are not the same device or the same type of device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event” or “in accordance with a determination that [the stated condition or event],” depending on the context.

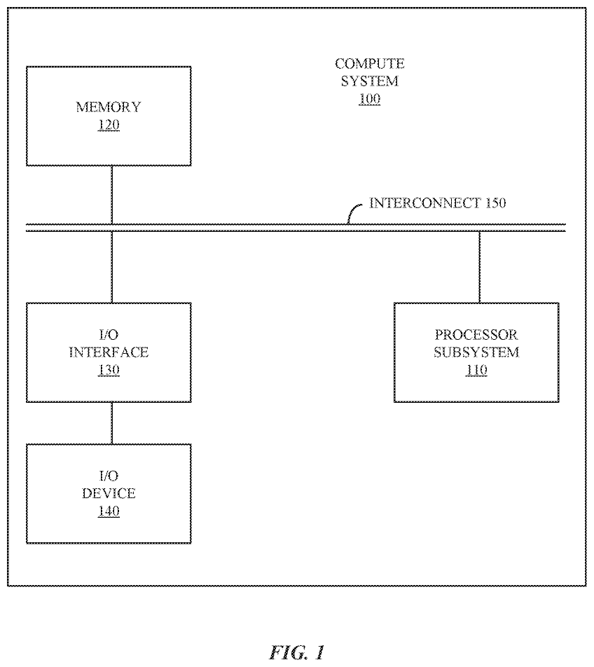

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 coupled (e.g., wired or wirelessly) to memory 120 (e.g., a system memory) and I/O interface 130 via interconnect 150 (e.g., a system bus, one or more memory locations, or other communication channel for connecting multiple components of compute system 100). In addition, I/O interface 130 is coupled (e.g., wired or wirelessly) to I/O device 140. In some examples, I/O interface 130 is included with I/O device 140 such that the two are a single component. It should be recognized that there can be one or more I/O interfaces, with each I/O interface coupled to one or more I/O devices. In some examples, multiple instances of processor subsystem 110 can be coupled to interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included with or coupled to a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a lidar sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX)), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready).

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above), such that different operations of the application are included with different nodes in the graph architecture.

In some examples, a message sent from a first node in a graph architecture to a second node in the graph architecture is performed using a publish-subscribe model, where the first node publishes data on a channel in which the second node is able to subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

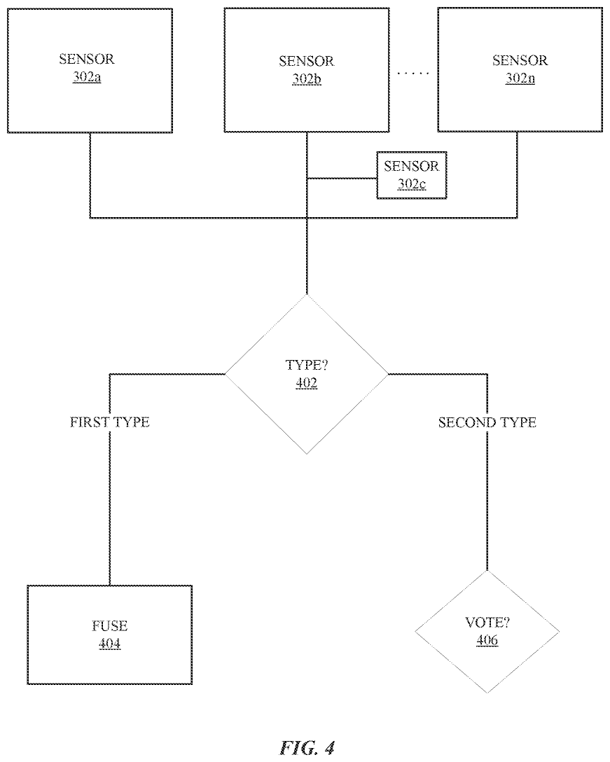

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with the flow described in FIG. 4.

Memory 120 can be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage, such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to couple to and communicate with other devices. In some examples, I/O interface 130 includes a bridge chip (e.g., Southbridge) from a front-side bus to one or more back-side buses. I/O interface 130 can be coupled to one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, lidar, ultrasonic sensor, GPS, inertial measurement device, or the like), and auditory or visual output devices (e.g., speaker, light, screen, projector, or the like). In some examples, compute system 100 is coupled to a network via a network interface device (e.g., configured to communicate over Wi-Fi, Bluetooth, Ethernet, or the like). In some examples, compute system 100 is directly or wired coupled to the network.

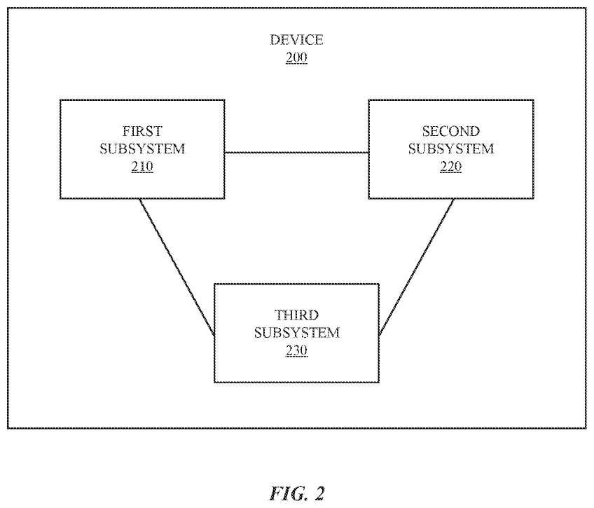

FIG. 2 illustrates a block diagram of device 200 with interconnected subsystems. In the illustrated example, device 200 includes three different subsystems (i.e., first subsystem 210, second subsystem 220, and third subsystem 230) coupled (e.g., wired or wirelessly) to each other. An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input (e.g., direct user input or indirect user input)) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision-making. In some examples, at least a portion of device 200 functions as a distributed compute system. For example, a task can be split into different portions, where a first portion is executed by first subsystem 210 and a second portion is executed by second subsystem 220.

Attention is now directed towards techniques for selecting sensor data. The techniques discussed herein can select sensor data from a group of sensor data captured by different system using a voting mechanism. Notably, the examples provided below are merely examples of the various techniques described by this disclosure and is not intended to limit the subject matter of the various techniques. It should be recognized, however, that such description is not intended as a limitation on the scope of the present disclosure. Instead, such description is provided as a description of exemplary embodiments.

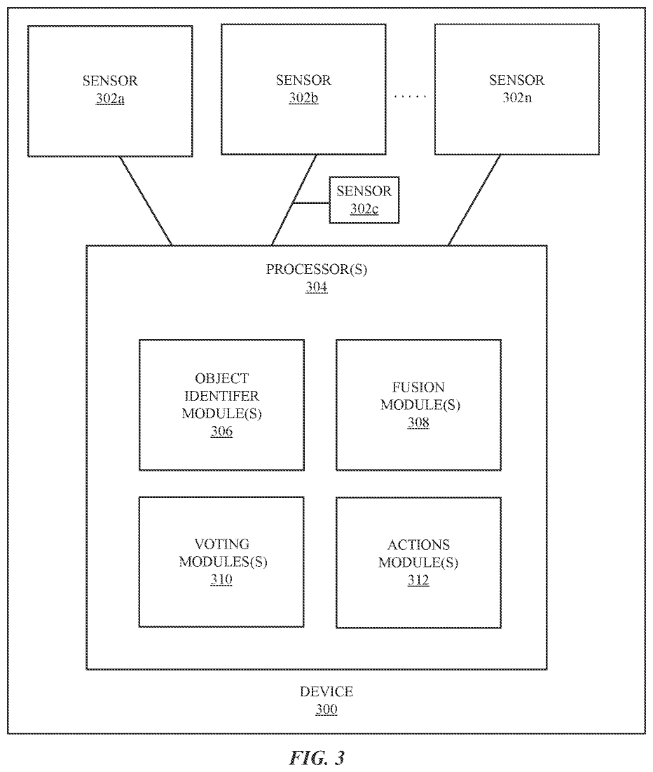

FIG. 3 is a block diagram illustrating device 300. Device 300 is a non-limiting example of a compute system and/or device used to perform the functionality described herein. It should be recognized that other computer architectures of a compute system and/or device can be used to perform functionality described herein.

As illustrated in FIG. 3, device 300 includes processor(s) 304 and sensors 302a-302n (“the sensors”). In some examples, device 300 includes one or more components of compute system 100, including processor subsystem 110, memory 120, I/O interface 130, I/O device 140, and interconnect 150. In some examples, device 300 includes one or more components of device 200, including first subsystem 210, second subsystem 220, and third subsystem 230. In some examples, processor(s) 304 include one or more features described above in relation to processor subsystem 110. In some examples, the sensors include one or more features described above in relation to I/O device 140.

At FIG. 3, each of the sensors is configured to capture a different type of sensor data than the other sensors. For example, a sensor in the sensors can be a radar sensor that captures radar data, a lidar sensor that captures lidar data, or a camera sensor (e.g., a telephoto sensor, a wide-angle sensor, an ultra-wide-angle, or infrared sensor) that captures camera data (e.g., high-resolution and/or low-resolution camera data). While FIG. 3 illustrates sensors 302a-302n as being included in device 300, in some examples, sensors 302a-302n are not included in device 300 and, instead, are in communication with device 300 via a wired or wireless connection. In some examples, some of sensors 302a-302n are included in device 300 while some of sensors 302a-302n are not included in device 300. In some examples, sensor 302a is a camera sensor while sensors 302b-302n are other sensors, such as radar sensors and/or lidar sensors. In some examples, sensor 302a is a high-resolution camera sensor while sensor 302b is a low-resolution camera sensor.

After the sensors have captured the sensor data, processor(s) 304 receives the captured sensor data and passes the captured sensor data to one or modules (e.g., processes) running on processor(s) 304. In some examples, processor(s) 304 passes the captured sensor data to the one or more modules after performing one or more computations using the sensor data, such as a computation to generate a depth value and/or a depth map and/or a process to astatize the sensor data. In some examples, the captured sensor data is fused (e.g., data from sensor 302b is fused with data from sensor 302c) before and/or after processor(s) 304 receives the sensor data. In some examples, captured sensor data that is a fusion of one or more sensors is perceived and/or treated by processor(s) 304 as being provided by a unique sensor (e.g., that is a combination of data from a first sensor with data from a second sensor, different from the first sensor). In some examples, fusing sensor data includes providing sensor data (e.g., such as images and/or data corresponding to values (e.g., depth values) that is captured by a respective sensor) to an intermediate processor (e.g., a microprocessor, such as one or more integrated circuits) that fuses the sensor data (e.g., using an averaging process, such as weighted averaging process) before providing the sensor data to processor(s) 304.

As illustrated in FIG. 3, the one or more modules include object identifier module(s) 306, fusion module(s) 308, voting module(s) 310, and action(s) module(s) 312. Object identifier module(s) 306 include one or more processes that identify objects based on (e.g., within or using data derived from) the captured sensor data. While device 300 is on (e.g., moving, operating, turned on, and/or stationary but operating), device 300 detects objects at varying distances from device 300 using the sensor data and identifies the objects via object identifier module(s) 306. As a part of identifying objects, object identifier module(s) 306 include one or more processes for classifying an object and determining whether an object is a particular type of object. In some examples, the sensor data used to detect and/or identify the object is detected by a different sensor than the sensor data that is fused (e.g., using one or more techniques below as described in relation to fusion module(s) 308) or than is selected (e.g., using one or more techniques below described in relation to voting module(s) 310). In some examples, identifying the object includes classifying the object (e.g., classifying the object as a ball, a desk, a motorcycle, a person, and/or a refrigerator). In some examples, the type of object is determined based on the distance between device 300 and the object at a particular instance in time. In some examples, the type of object includes a rating. In some examples, the rating includes criticality rating, an urgency rating, and/or importance rating for the object. In some examples, a closer object receives a rating that communicates a higher level of importance and/or urgency than an object that is further away. In some examples, the rating for an object depends on a moving speed of the device (e.g., if the device is moving faster toward the object, the object receives a rating that communications a more important/urgent than if the device is moving slower toward the object). In some examples, the rating is based on an integrity standard that provides a level of risk with respect to the movement and/or position of the object and the movement and/or position of device 300. In some examples, the rating is based on the type of object. In some examples, the rating is based on the current conditions in which device 300 is operating.

Fusion module(s) 308 includes one or more processes for fusing sensor data. In some examples, by fusing data captured by one or more sensors, fusion module(s) 308 assists with the computation of a depth value and/or generation of one or more depth maps based on the fused sensor data. In some examples, in response to determining than an object is not associated with a high enough level of importance (and/or in order to determine that the object is not associated with the high enough level of importance), device 300 determines a depth value by fusing captured data from one or more sensors (e.g., two of sensors 302a-302n, three of sensors 302a-302n, and/or more of sensors 302a-302n) using fusion module(s) 308. In some examples, determining the depth value based on sensor data, includes determining the depth of an object by triangulating a position of the object using images (or sensor data). In some examples, device 300 uses fused sensor data from multiple sensors to detect environmental conditions surrounding device 300. In some examples, using fused data from multiple sensors is preferred over using data from only one sensor to create a higher degree of certainty that one or more environmental conditions are present. In some examples, one or more different types of the sensors are better in certain environmental conditions (e.g., at night, in the rain, and/or in the snow) than other types of the one or more sensors. In some examples, sensor data detected by a sensor at a first period of time is fused with sensor data captured by a sensor at a second period of time that is different from the first period of time.

Voting module(s) 310 includes one or more processes for selecting between different types of sensor data to use (and/or verify) in order to calculate a depth value (or a value that is associated with a depth value) and/or generate a depth map based on the captured sensor data. In some examples, in response to determining that an object is associated with a high enough level of importance (and/or in order to determine that the object is associated with the high enough level of importance), device 300 use voting module(s) 310 to select a respective depth value generated by a sensor when the depth values calculated by the sensors are not congruent (e.g., when the sensors disagree on a depth value). In some examples, voting module(s) 310 selects a respective depth value generated by a sensor from a group of depth values generated by the sensors based on criteria. In some examples, the criteria include determining whether previous depth values detected by a sensor was incorrect or correct, a sensor historical performance in current environmental conditions were incorrect or correct, whether the sensor type of a sensor is known to perform well in current environmental conditions, whether a sensor is known to detect a respective object well (e.g., the object for which a depth value is being calculated), and/or whether depth values detected by one or more other sensors are congruent with a sensor. In some examples, device 300 uses voting module(s) 310 to select a respective depth value generated by a sensor when the depth values calculated by the sensors are not congruent is preferred over using data from only one sensor and/or using fused data from multiple sensors to create a higher degree of certainty that one or more environmental conditions are present. In some examples, one or more different types of the sensors are better in certain environmental conditions (e.g., at night, in the rain, and/or in the snow) than other types of the one or more sensors; thus, using the voting mechanism can be preferred over using data from only one sensor and/or using fused data from multiple sensors to determine a more accurate value (e.g., with the distance between device 300 and an object is below a threshold level of distance). In some examples, fusing sensor data from multiple sensors removes variations between different values to get a likely compromise that is almost certainly not the real value while using a voting mechanism allows the device to select a real value (e.g., a value that is determined to be the best real value among other values).

Action(s) module(s) 312 includes one or more processes that cause the device 300 to perform one or more operations in response to a calculated depth map and/or depth value for a particular object. Depending on the generated depth map and/or depth value, device 300 can be caused to perform one or more operations (e.g., decrease or increase brightness, turn off, vibrate, and/or decrease or increase movement) to avoid an object using action(s) module(s) 312. Action(s) module(s) 312 can also include one or more operations that cause a notification to be sent to a user, cause data to be saved/stored regarding the calculated and/or selected depth value(s) for an object, and/or cause data to be saved/stored regarding whether voting module(s) 310 was used to select the depth value (e.g., from different values calculated by the sensors) and/or generate a depth map for an object (e.g., from different values calculated by the sensors).

FIG. 4 is a block diagram illustrating a technique for using sensor data while a device is operating in the physical environment (e.g., at run-time and/or not offline). As illustrated in FIG. 4, sensors 302a-302n captures different types of sensor data. In some examples, the sensor data for one or more sensors is fused (e.g., using similar techniques as described above in relation to fusion module(s) 308 of FIG. 3). At block 402 of FIG. 4, a device (e.g., device 300) determines whether an object is a first type of object or a second type of object using the sensor data captured by the sensors. In some examples, the sensors have overlapping fields of view and/or overlapping fields of detection. In some examples, an object that is a first type of object is an object that is further away from the device than an object that is the second type of object. In some examples, the object that is the first type of object is less important/urgent and/or given a rating that communicates that the object is less important than the importance/urgency and/or rating that is given to an object that is the second type of object. At block 404, if the object is determined to be the first type of object, the device fuses the data from the sensors to generate an output, using one or more techniques as described above in relation to fusion module(s) 308. At block 406, if the object is determined to be the second type of object, the device determines whether a voting mechanism (e.g., voting module(s) 310) will be used to decide which value generated by the sensor data should be used to generate an output.

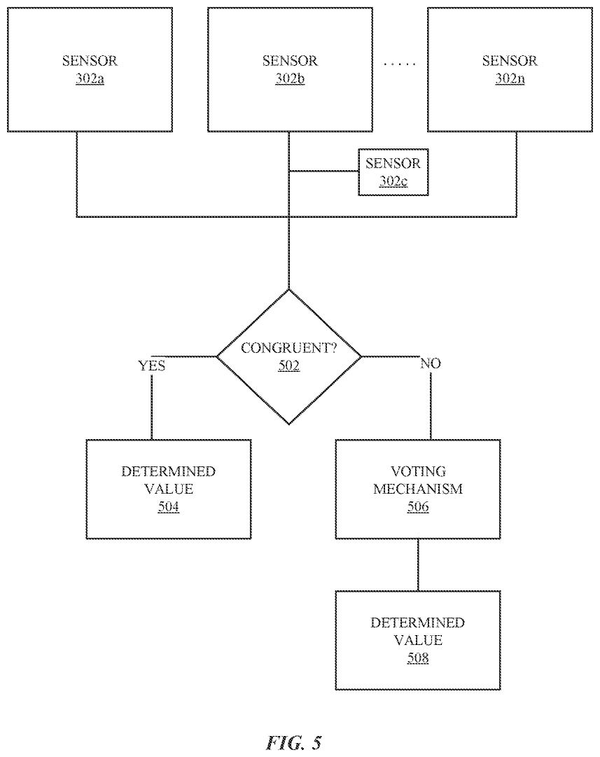

FIG. 5 is a block diagram illustrating a technique for determining whether to use the voting mechanism (or voting module(s)). At block 502, a device (e.g., device 300) detects whether the sensor data from sensors 302a-302n is congruent (e.g., equal and/or within a range of each other) or not. It should be understood that the process described in relation of FIG. 5 is a continuation of block 408 of FIG. 4. At 504, in response to determining that the sensor data is congruent, the device generates output based on the sensor data (e.g., a fusion of the sensor data and/or a selection of data from one sensor of the sensors (e.g., choosing to generate a value using the fused sensor data from multiple sensor or choosing to generate a value using the selected data from a sensor (e.g., that is not fused with a different type of sensor)). In some examples, because the sensor data from the sensors is congruent, the device merely selects the congruent value associated with the sensor data from the sensors. In some examples, because the sensor data from the sensors is congruent, the device generates output using a fusion of the sensor data (e.g., from the sensors) without using the voting mechanism. At blocks 506-508, in response to determining that the sensor data is not congruent, the device uses a voting mechanism (e.g., voting module(s) 310 of FIG. 3) to select data from at least one sensor from the group of sensors in order to generate output (e.g., choose sensor data from one sensor from sensor data detected by the group of sensors and using the chosen sensor data from the one sensor to generate a depth value). In some examples, in response to determining that an object is further than a first distance away from the device, the device disables use of the voting mechanism. In some examples, in response to determining that an object is not further than a first distance away from the device, the device enables use of the voting mechanism. In some examples, the voting mechanism can sometimes produce inaccurate results for objects that are further away from the device, so the voting mechanism can be disabled for detecting the distance of objects that are further than a predetermined threshold (e.g., 5-100 meters). Thus, the voting mechanism is selectively enabled or disabled in some examples. In such examples, the device can use sensor fusion to detect the distance of an object (e.g., fusing sensor data together from one or more sensors).

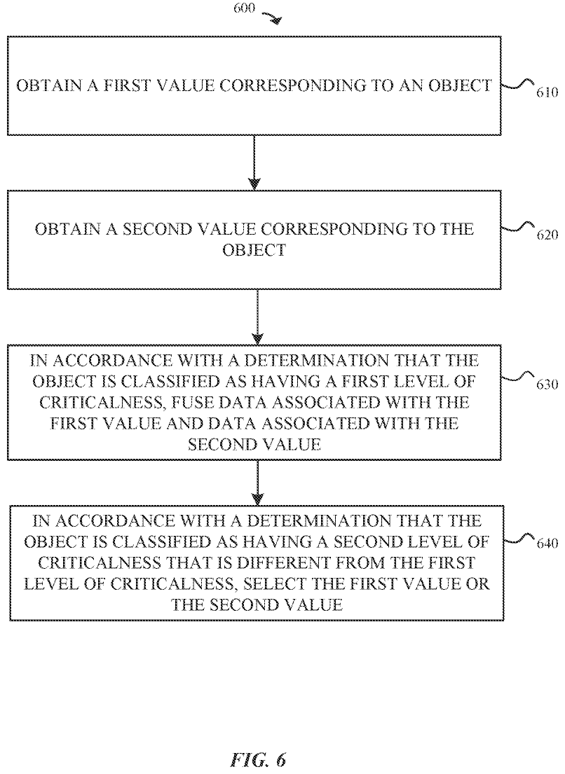

FIG. 6 is a flow diagram illustrating method 600 for determining whether to fuse sensor data. Some operations in method 600 are, optionally, combined, the orders of some operations are, optionally, changed, and some operations are, optionally, omitted. In some examples, method 600 is performed at a processor (e.g., a processing unit (e.g., a computer processing unit or a graphical processing unit) and/or one or more processors) of an electronic device (e.g., a computer system, a phone, a tablet, a motorized electronic device, a wearable electronic device, a personal computer, and/or an autonomous electronic device) that is in communication with a first sensor (e.g., a sensors that captures depth data, a sensor that captures data, where depth data can be determined, a camera sensor, a lidar sensor, and/or a radar sensor) and a second sensor (e.g., a sensors that captures depth data, a sensor that captures data, where depth data can be determined, a camera sensor, a lidar sensor, and/or a radar sensor) that is different from the first sensor. In some examples, the field-of-view or field-of-detection of the first sensor overlaps with the field-of-view of the second sensor. In some examples, the first sensor can detect and/or capture objects at a different distance (e.g., shorter distance and/or longer distance) than the second sensor can detect and/or capture objects). In some examples, the first sensor performs better or worst in certain conditions (e.g., environmental conditions and/or historical conditions) than the second sensor.

At block 610, the electronic device obtains (e.g., received, acquiring, and/or capturing), via the first sensor, a first value (e.g., a depth, a location, and/or an identity value) corresponding to an object (e.g., via at least one of the two or more sensors) (e.g., a physical object, a person, a vehicle, a house, a mattress, a sign, and/or a building) (e.g., in a physical environment) (e.g., an object that is in the field-of-view and/or field-of-sensory of the first sensor and the second sensor).

At block 620, the electronic device obtains (e.g., received, acquiring, and/or capturing), via the second sensor, a second value (e.g., a depth, a location, and/or an identity value) corresponding to the object.

At block 630, in accordance with a determination that the object is classified as having a first level of criticalness (e.g., after/before obtaining the first value and the second value) (e.g., level of importance and/or urgency) (e.g., an object that has a first level of criticalness and/or an object that is a first distance from the electronic device) (e.g., based on a safety integrity level standard and/or a movement standard), fusing the electronic device fuses data associated with the first value (e.g., data captured by the first sensor and/or the first value) and data associated with the second value (e.g., data captured by the second sensor and/or the second value) (e.g., and/or by fusing the first value and the second value and/or fusing data captured by the first sensor and data captured by the second sensor) (e.g., without selecting the first value or the second value). In some examples, the electronic devices generating a third value corresponding to the object by fusing data associated with the first value and data associated with the second value.

At block 640, in accordance with a determination that the object is classified as having a second level of criticalness that is different from the first level of criticalness (e.g., after/before obtaining the first value and the second value) (e.g., an object that has a second level of criticalness that is more critical than the first level of critical and/or an object that is a second distance from the electronic device that is greater than the first distance) (e.g., based on a safety integrity level standard and/or a movement standard), the electronic device selects the first value or the second value (and/or by not fusing data associated with the first value and data associated with the second value). In some examples, the computer system generates the third value corresponding to the object by selecting the first value or the second value. In some examples, the electronic device selecting the first value or the second value (e.g., by fusing data from one sensor) generates a value from sensor data that was originally detected by the one or more sensors, whereas fusing the sensor data generates a value from sensor data that was not originally detected by the one or more sensors.

In some examples, the first value is generated based on first sensor data that is detected (and/or captured) by the first sensor. In some examples, the first sensor data is a first type of sensor data. In some examples, the second value is generated based on second sensor data that is detected (and/or captured) by the second sensor. In some examples, the second sensor data is a second type of sensor data that is different from the first type of sensor data. In some examples, the first sensor is a first type of sensor. In some examples, the second sensor is a second type of sensor that is different from the first type of sensor.

In some examples, the first type of sensor data has a first resolution (e.g., resolution generated by a telephoto camera or a wide-angle camera). In some examples, the second type of sensor data has a second resolution (e.g., resolution generated by an ultra-wide angle camera). that is different from the first resolution. In some examples, the first sensor data and the second sensor data are generated using the same type of sensor (e.g., camera, lidar, and/or radar). In some examples, the sensor data with the second resolution has a higher or lower number of pixels than the sensor data with the first resolution.

In some examples, the second sensor captures sensor data that is a same type of sensor data (e.g., lidar, radar, camera, or any combination thereof) that is captured by the first sensor. In some examples, the first value and the second value are generated based on data from a set of one or more sensors that includes the first sensor and the second sensor (e.g., using a dense band as first sensor and sparse band as second sensor).

In some examples, in accordance with a determination that the object is classified as having the second level of criticalness, the first value or the second value is selected using a voting mechanism (e.g., algorithm, model, and/or decision engine). In some examples, the voting mechanism selects the first value or the second value by determining whether which value matches (or within a threshold of) a third value. In some examples, determining whether a plurality of values is congruent includes a determination that at least one value is not congruent with at least another value or determining that the majority of the plurality of values are not congruent.

In some examples, in conjunction with fusing data associated with the first value (e.g., data captured by the first sensor and/or the first value) and data associated with the second value, the electronic device stores data that includes an indication that sensor fusion was used (e.g., and/or data associated with the first value and data associated with the second value was fused) (and, in some examples, does not include an indication that the voting mechanism was used to select the first value or the second value). In some examples, in conjunction with (e.g., after, before, and/or while) using the voting mechanism to select the first value or the second value, the device stores (e.g., causes data to be saved and/or stored) data that includes an indication that the voting mechanism was used to select the first value or the second value (and, in some examples, that includes an indication of the value (e.g., first value or second value) that was selected) (e.g., in a database and/or on a cloud server).

In some examples, fusing the data associated with the first value and the data associated with the second value includes averaging (in some examples, at least) a subset (e.g., all or some but not all) of the data associated with the first value with (in some examples, at least) a subset of the data associated with the second value. In some examples, averaging (in some examples, at least) the subset of the data associated with the first value with (in some examples, at least) the subset of the data associated with the second value is performed using an average bias (and/or one or more average biases).

In some examples, the first sensor is (and/or the second sensor) at least one selected from a group of a camera sensor (e.g., a short-range, long-range, telephoto, wide-angle, and/or ultra-wide-angle camera), a lidar sensor, and a radar sensor. In some examples, the first sensor is a pair of camera sensors (e.g., a stereo pair and/or a pair of cameras and/or camera sensors that used to identify and/or compute a depth value).

In some examples, the first value is obtained via the first sensor and a third sensor that is different from the first sensor. In some examples, the first value includes a combination (e.g., a fusion of and/or an average of) of data detected by the first sensor and data detected by the third sensor (e.g., a camera sensor and a lidar sensor, a camera sensor and a radar sensor, a lidar sensor and a radar sensor, a short-range camera sensor and a long-range camera sensor, and/or any combination thereof). In some examples, data generated by the first sensor is a combination of data generated by one sensor and data generated by another sensor.

In some examples, before obtaining the first value and the second value, the electronic device detects (e.g., identifying a type or otherwise determining a label for) the object using respective data. In some examples, the determination of whether the object is classified as having the first level of criticalness and the determination of whether the object is classified as having the second level of criticalness are not made using the respective data (and before detecting the object using the respective data).

In some examples, the first level of criticalness of the object is based on at least one characteristic selected from the group of a distance between a respective electronic device (the electronic device and/or another electronic device) and the object, a direction from the electronic device to the object (and/or the direction of the object from the object to the electronic device), movement (e.g., velocity and/or acceleration) of the respective electronic device and/or the object, and the type of object.

In some examples, in accordance with a determination that the object is classified as having the second level of criticalness and the first value is not congruent (e.g., consistent with, is not equal to, does not translate to an approximation of, and/or is not an approximation of) with the second value, the electronic device performs an action (e.g., a first action (e.g., braking, stopping, and/or moving) and/or an avoidance action) based on the first value or the second value. In some examples, in accordance with a determination that the object is classified as having the first level of criticalness and the first value is not congruent with the second value, the electronic device forgoes performing the action (e.g., the first action) based on the first value or the second value.

Note that details of the processes described with respect to method 600 (e.g., FIG. 6) are also applicable in an analogous manner to methods 700 and 800. For example, method 600 optionally includes one or more of the characteristics of the various methods described above with reference to method 700. For example, method 600 can be used to determine whether to generate an output using fused data while method 700 can be used to determine whether to generate an output using a voting mechanism. The details of all these combinations are not presented here for the sake of brevity.

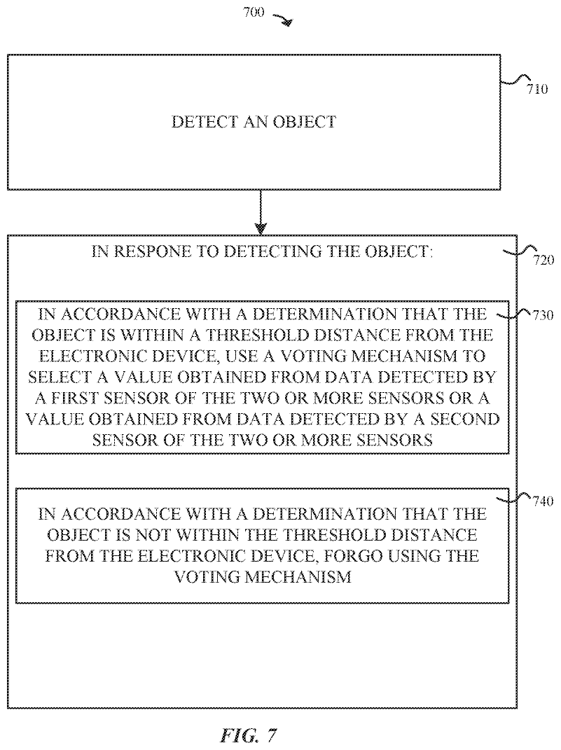

FIG. 7 is a flow diagram illustrating method 700 for determining whether to use a voting mechanism. Some operations in method 700 are, optionally, combined, the orders of some operations are, optionally, changed, and some operations are, optionally, omitted. In some examples, method 700 is performed at a processor (e.g., a processing unit (e.g., a computer processing unit or a graphical processing unit) and/or one or more processors) of an electronic device (e.g., a computer system, a phone, a tablet, a motorized electronic device, a wearable electronic device, a personal computer, and/or an autonomous electronic device) that is in communication with two or more sensors (e.g., a first sensor (e.g., a camera sensor, a lidar sensor, and/or a radar sensor) and a second sensor (e.g., a camera sensor, a lidar sensor, and/or a radar sensor) that is different from the first sensor, a third sensor that is different from the first sensor and the second sensor, a fusion of two or more of the first sensor, second sensor, and third sensor, a sensor that captures depth data, and/or a sensor that captures data, where depth data can be determined). In some examples, the field-of-view or field-of-detection of the first sensor overlaps with the field-of-view or field-of-detection of the second sensor and/or the field-of-view or field-of-detection of the third sensor. In some examples, the first sensor can detect and/or capture objects at a different distance (e.g., shorter distance and/or longer distance) than the second sensor and/or the distance at which the third sensor can detect and/or capture objects. In some examples, the first sensor and/or the third sensor performs better or worse in certain conditions (e.g., environmental conditions and/or historical conditions) than the second sensor.

At block 710, the electronic device detects an object (e.g., via at least one of the two or more sensors) (e.g., a physical object, a person, a vehicle, a house, a mattress, a sign, and/or a building) (e.g., using a sensor and/or in capture sensor data that is periodically captured and/or that is captured in response to a user input and/or a condition (e.g., a weather-based condition, a road-based condition, a time based condition) being satisfied.

At blocks 720 and 730, in response to detecting the object and in accordance with a determination that the object is within a threshold distance (e.g., after/before obtaining a first value and a second value) (e.g., and/or the object is associated with a certain level of critical ness) (e.g., based on a integrity level and/or a movement standard) (e.g., 1-50 meters) (e.g., a threshold distance that changes based on movement of the electronic device, conditions in the physical environment, and/or movement one or more objects in the physical environment) from the electronic device, the electronic device uses a voting mechanism (e.g., algorithm, model, and/or decision engine) to select a value (e.g., a depth, a location, and/or an identity value) obtained from data detected by (e.g., obtained from, acquired by, and/or captured by) a first sensor of the two or more sensors or a value (e.g., a depth, a location, and/or an identity value) obtained from data detected by a second sensor of the two or more sensors (and, in some examples, a third sensor of the two or more sensors).

At blocks 720 and 740, in response to detecting the object and in accordance with a determination that the object is not within the threshold distance from the electronic device, the electronic device forgoes using the voting mechanism (e.g., to select the value obtained from data detected by the first sensor and/or the value obtained from data detected by the second sensor).

In some examples, in response to detecting the object and in accordance with a determination that the object is not within the threshold distance from the electronic device (e.g., and/or a determination that a value for the object should be detected), the electronic device selects a value by fusing data detected by the first sensor and data detected by the second sensor (e.g., average data from two sensors and/or biased average data from two sensors).

In some examples, the electronic device detects a second object. In some examples, in response to detecting the second object and in accordance with a determination that the second object is within a second threshold distance from the electronic device and that a second value obtained from data detected by the first sensor with respect to the second object and a second value obtained from data detected by the second sensor with respect to the second object are congruent (e.g., is equal to, translates to an approximation of, and/or is an approximation of), the electronic device selects the second value obtained from data detected by the first sensor or the second value obtained from data detected by the second sensor without using the voting mechanism (e.g., using sensor fusion to fuse data detected from the first and second sensors or choosing one of the values since they are congruent). In some examples, in response to detecting the second object and in accordance with a determination that the second object is within the second threshold distance from the electronic device and that the second value obtained from data detected by the first sensor and the second value obtained from data detected by the second sensor are not congruent (e.g., is not equal to, does not translate to an approximation of, and/or is not an approximation of), the electronic device uses the voting mechanism to select the second value obtained from data detected by the first sensor or the second value obtained from data detected by the second sensor.

In some examples, in conjunction with (e.g., after, before, and/or while) using the voting mechanism (e.g., to select the value obtained from data detected by the first sensor or the value obtained from data detected by the second sensor), the electronic device detects a change in the direction of the electronic device. In some examples, in response to detecting the change in the direction of the electronic device and in accordance with a determination that the object is within the threshold distance from the electronic device and the electronic device is traveling in a direction toward the object (and/or, in some examples, the object is traveling in a direction toward the electronic device) (and/or in some examples, the distance between the electronic device and the object is getting shorter over time), the electronic device uses the voting mechanism with respect to the object (e.g., with respect to selecting one or more values obtained from data detected by the first sensor and one or more values obtained from data detected by the second sensor). In some examples, in response to detecting the change in the direction of the electronic device and in accordance with a determination that the object is within the threshold distance from the electronic device and the electronic device is not traveling in the direction toward the object (and/or, in some examples, the object is not traveling in a direction toward the electronic device)) (and/or in some examples, the distance between the electronic device and the object is not getting shorter over time), the electronic device forgoes using the voting mechanism with respect to the object. In some examples, after ceasing to use the voting mechanism with respect to the object, the electronic device detects a second change in the direction of the electronic device; and in response, the electronic device starts using the voting mechanism with respect to the object.

In some examples, the data detected by the first sensor is a first type of sensor data. In some examples, the data detected by the second sensor is a second type of sensor data that is different from the first type of sensor data. In some examples, the first sensor is a first type of sensor. In some examples, the second sensor is a second type of sensor that is different from the first type of sensor.

In some examples, the first sensor is (and/or the second sensor) at least one selected from a group of a camera sensor (e.g., a short-range, long-range, telephoto, wide-angle, and/or ultra-wide-angle camera), a lidar sensor, and a radar sensor.

In some examples, in accordance with a determination that movement characteristics (e.g., acceleration, direction, velocity, and/or speed) of electronic device (and/or, in some examples, the object) has a first set of movement characteristics, the threshold distance is a first distance. In some examples, in accordance with a determination that movement characteristics (e.g., acceleration, direction, velocity, and/or speed) of electronic device (e.g., and/or (or in some examples, and; or in some examples, or) the object) has a second set of movement characteristics that is different from the first set of movement characteristics, the threshold distance is a second distance that is different from the first threshold distance. In some examples, the threshold distance is dynamic (e.g., determined based on the movement of the electronic device (e.g., in relation to the object) and/or the movement of the object. In some examples, as the electronic device moves towards the object at a faster rate, the threshold distance decreases.

In some examples, as a part of using the voting mechanism, the electronic device applies a first weight (e.g., a weight of important, a weight of priority, and/or a voting weight) to select the value obtained from data detected by the first sensor based on an environmental condition (e.g., a weather condition (e.g., raining, snowing, and/or sunny), a road condition (e.g., muddy terrain, gravel terrain, normal road conditions, and/or snow, icy, and/or wet road conditions), traffic conditions (e.g., stop and go traffic or free and clear traffic), daytime, evening, and/or nighttime); and applies a second weight to select the value obtained from data detected by the second sensor based on the environmental condition. In some examples, the first weight is different from (e.g., a different numeral value and/or representation than) the second weight. In some examples, the first weight is based on the sensor type of the first sensor and the environmental condition (e.g., a numerical value (e.g., a value on a scale (e.g., 0 to 1)) that indicates whether or not and/or how well the first sensor performs well or does not perform well in the environmental condition) and the second weight is based on the sensor type of the second sensor (e.g., a numerical value (e.g., a value of the scale) that indicates whether or not and/or how well the second sensor performs well or does not perform well in the environmental condition). In some examples, after applying the first weight (e.g., a weight of important, a weight of priority, and/or a voting weight) to select the value obtained from data detected by the first sensor based on an environmental condition and applying the second weight to select the value obtained from data detected by the second sensor based on the environmental condition, the voting mechanism selects the value obtained from data detected by the first sensor when the total weight(s) applied (e.g., including the first rate) for the value obtained from detected by the first sensor is greater than (or, in some examples) the total weight(s) applied for the value obtained from data detected by the second sensor (or selects the value obtained from data detected by the second sensor when the total weight(s) applied (e.g., including the first rate) for the value obtained from detected by the second sensor is greater than (or, in some examples) the total weight(s) applied for the value obtained from data detected by the first sensor).

In some examples, as a part of using the voting mechanism, the electronic device applies a third weight (e.g., a weight of important, a weight of priority, and/or a voting weight) to select the value obtained from data detected by the first sensor based on a determination of quality (e.g., accuracy, dependability, and/or reliability) of previous data detected by the first sensor (e.g., previous data before the object was detected and/or the value obtained by the first sensor or second sensor was detected); and applies a fourth weight to select the value obtained from data detected by the second sensor based on quality of previous data detected by the second sensor. In some examples, the third weight is different from (e.g., a different numeral value and/or representation than) the fourth weight and/or the quality of data detected by the first sensor is different from the quality of previous data detected by the second sensor.

In some examples, the voting mechanism does not solely select a respective value based on whether most of the values are the same (e.g., not solely based on whether a value detected by multiple sensors is chosen (e.g., over a value detected by only one or less than the number of the multiple sensors)). In some examples, the object is detected (and/or the voting mechanism is used, the value is selected via the voting mechanism, and/or fusion occurs) while the electronic device is moving in the physical environment (e.g., occurs at runtime and/or not offline). In some examples, in accordance with a determination that the object is within the threshold distance, the electronic device identifies a level of criticalness of the object based on the voting mechanism. In some examples, in accordance with a determination that the object is not within the threshold distance, the electronic device forgoes identifying the level of criticalness of the object based on the voting mechanism. In some examples, in accordance with a determination that the object is within the threshold distance, the electronic device identifies a level of criticalness of the object using the value obtained from data detected by the first sensor or the value obtained from data detected by the second sensor (without fusing the data). In some examples, in accordance with a determination that the object is not within the threshold distance, the electronic device identifies level of criticalness of the object by fusing the value obtained from data detected by the first sensor and the value obtained from data detected by the second sensor (e.g., and/or without selecting one or more the other).

In some examples, in conjunction with (e.g., after, before, and/or while) using the voting mechanism, the electronic device stores (e.g., causing data to be saved and/or stored) data that includes an indication that the voting mechanism was used (e.g., to select the value obtained from data detected by the first sensor or the value obtained from data detected by the second sensor) (and, in some examples, that includes an indication of the value (e.g., first value or second value) that was selected) (e.g., in a database and/or on a cloud server).

Note that details of the processes described with respect to method 700 (e.g., FIG. 7) are also applicable in an analogous manner to methods 600 and 800. For example, method 600 optionally includes one or more of the characteristics of the various methods described above with reference to method 700. For example, method 600 can be used to determine whether to generate an output using fused data while method 700 can be used to determine whether to generate an output using a voting mechanism. The details of all these combinations are not presented here for the sake of brevity.

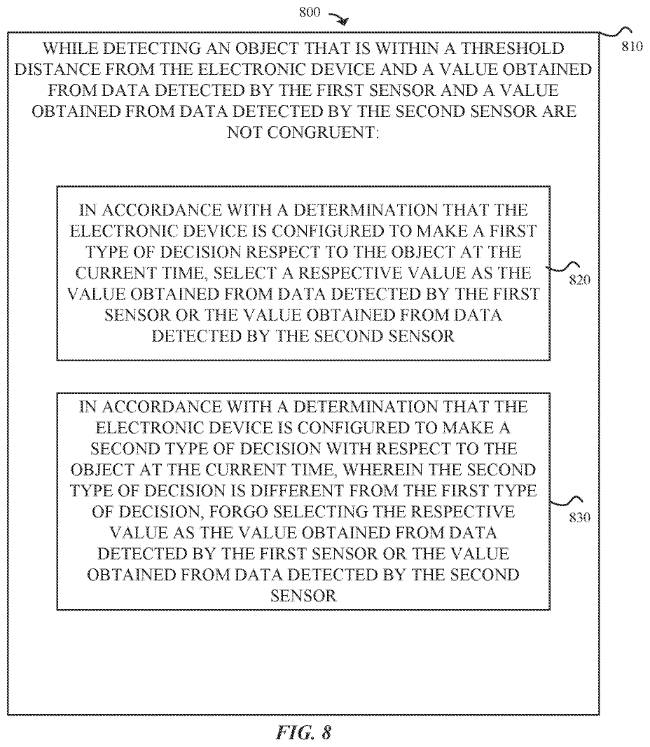

FIG. 8 is a flow diagram illustrating method 800 for responding to different types of decisions. Some operations in method 800 are, optionally, combined, the orders of some operations are, optionally, changed, and some operations are, optionally, omitted. In some examples, the method is performed at a processor (e.g., a processing unit (e.g., a computer processing unit or a graphical processing unit) and/or one or more processors) of an electronic device (e.g., a computer system, a phone, a tablet, a motorized electronic device, a wearable electronic device, a personal computer, and/or an autonomous electronic device) that is in communication with a first sensor (e.g., a sensor that captures depth data, a sensor that captures data, where depth data can be determined, a camera sensor, a lidar sensor, and/or a radar sensor) and a second sensor (e.g., a sensor that captures depth data, a sensor that captures data, where depth data can be determined, a camera sensor, a lidar sensor, and/or a radar sensor) that is different from the first sensor. In some examples, the field-of-view or field-of-detection of the first sensor overlaps with the field-of-view of the second sensor. In some examples, first sensor can detect and/or capture objects at a different distance (e.g., shorter distance and/or longer distance) than the second sensor can detect and/or capture objects). In some examples, the first sensor performs better or worst in certain conditions (e.g., environmental conditions and/or historical conditions) than the second sensor.

At blocks 810 and 820, while detecting an object (e.g., via at least one of the two or more sensors) (e.g., a physical object, a person, a vehicle, a house, a mattress, a sign, and/or a building) (e.g., in a physical environment) that is within a threshold distance (e.g., after/before obtaining a first value and a second value) (e.g., and/or the object is associated with a certain level of critical ness) (e.g., based on a integrity level standard and/or a movement standard) (e.g., 1-50 meters) (e.g., a threshold distance that changes based on movement of the electronic device, conditions in the physical environment, and/or movement one or more objects in the physical environment)) from the electronic device (and, in some examples, in response to receiving the request to perform the operation) and a value obtained from data detected by the first sensor and a value obtained from data detected by the second sensor are not congruent (e.g., is not equal to, does not translate to an approximation of, and/or is not an approximation of) and in accordance with a determination that the electronic device is configured to make a first type of decision (e.g., an urgent decision, a dynamic decision, and/or a critical decision) with respect to the object at the current time, the electronic device selects a respective value (e.g., a value that is used to perform an operation, such as breaking and/or avoiding an obstacle and/or object) as (e.g. that is equal to and/or to be) the value obtained from data detected by the first sensor or the value obtained from data detected by the second sensor (e.g., the respective value equals the value obtained from data detected by the first sensor or the value obtained from data detected by the second sensor). In some examples, selecting the respective value as (e.g., that is equal to and/or to be) a value obtained from data detected by the first sensor or a value obtained from data detected by the second sensor includes selecting the respective value using a voting mechanism (or a rules-based selection).

At blocks 810 and 830, while detecting an object (e.g., via at least one of the two or more sensors) (e.g., a physical object, a person, a vehicle, a house, a mattress, a sign, and/or a building) (e.g., in a physical environment) that is within a threshold distance (e.g., after/before obtaining a first value and a second value) (e.g., and/or the object is associated with a certain level of critical ness) (e.g., based on a integrity level standard and/or a movement standard) (e.g., 1-50 meters) (e.g., a threshold distance that changes based on movement of the electronic device, conditions in the physical environment, and/or movement one or more objects in the physical environment)) from the electronic device (and, in some examples, in response to receiving the request to perform the operation) and a value obtained from data detected by the first sensor and a value obtained from data detected by the second sensor are not congruent (e.g., is not equal to, does not translate to an approximation of, and/or is not an approximation of) and in accordance with a determination that the electronic device is configured to make a second type of decision (e.g., not an urgent decision, a dynamic decision, and/or a critical decision; and/or a tactical decision) with respect to the object at the current time, where the second type of decision is different from the first type of decision, the electronic device forgoes selecting the respective value as the value obtained from data detected by the first sensor or (e.g., and/or) the value obtained from data detected by the second sensor (e.g., the respective value does not equal the value obtained from data detected by the first sensor or the value obtained from data detected by the second sensor) (and, in some examples, without selecting the respective value as a value obtained from fusing data detected by the first sensor and data detected by the second sensor). In some examples, in accordance with a determination that the electronic device is configured to make the second type of decision with respect to the object at the current time, the respective value is a fusion of data detected by the first sensor and the second sensor. In some examples, in accordance with a determination that the electronic device is configured to make the second type of decision with respect to the object at the current time, the respective value is selected as the value detected by a different sensor (e.g., not the first sensor and the second sensor). In some examples, while the object is within the threshold distance from the electronic device and the value obtained from data detected by the first sensor and the value obtained from data detected by the second sensor are congruent, the respective value is selected as a fusion of data detected by the first sensor and data detected by the second sensor or as the value obtained from data detected by the first sensor or a value obtained from data detected by the second sensor (e.g., because the values are congruent no voting mechanism is used).

In some examples, the first type of decision is a decision that is designated as requiring one or more respective operations to be performed (e.g., based on current distance from object, based on time, and/or based on direction that electronic device is traveling with respect to the object) (e.g., a decision to avoid an immediate hazard and/or obstruction). In some examples, the second type of decision is not a decision that requires one or more respective operations to be performed (e.g., not a decision to avoid an immediate hazard and/or obstruction).

In some examples, the first type of decision is made based on one or more respective objects in a physical environment. In some examples, the second type of decision is not made based on one or more respective objects in the physical environment.

In some examples, while detecting the object that is within the threshold distance from the electronic device and in accordance with a determination that the electronic device is configured to make the first type of decision and the value obtained from data detected by the first sensor is not congruent with the value obtained from data detected by the second sensor, the electronic device performs one or more operations (e.g., performing an operation (e.g., braking, stopping, and/or moving) and/or an avoidance operation and/or using a voting mechanism to select the respective value) (e.g., with respect to the object and/or the electronic device). In some examples, while detecting the object that is within the threshold distance from the electronic device and in accordance with a determination that the electronic device is configured to make the second type of decision and the value obtained from data detected by the first sensor is not congruent with the value obtained from data detected by the second sensor, the electronic device forgoes performing one or more operations.

In some examples, the first sensor is (and/or the second sensor) at least one selected from a group of a camera sensor (e.g., a short-range, long-range, telephoto, wide-angle, and/or ultra-wide-angle camera), a lidar sensor, and a radar sensor. In some examples, the first value is obtained via the first sensor and a third sensor that is different from the first sensor. In some examples, the first sensor and the third sensor is at least one selected from a group of a camera sensor (e.g., a short-range, long-range, telephoto, wide-angle, and/or ultra-wide-angle camera), a lidar sensor, and a radar sensor (e.g., a camera sensor and a lidar sensor, a camera sensor and a radar sensor, a lidar sensor and a radar sensor, a short-range camera sensor and a long-range camera sensor, and/or any combination thereof). In some examples, data generated by the first sensor is a combination of data generated by one sensor and data generated by another sensor.

In some examples, while detecting a respective object that is not within the threshold distance from the electronic device and in accordance with a determination that the electronic device is configured to make the first type of decision, the electronic device selects the respective value by fusing data obtained from data detected by the first sensor and data obtained from data detected by the second sensor (e.g., irrespective of whether the sensors disagree and/or whether a value obtained from data detected by the first sensor is congruent with a value for the second sensor) (e.g., without using the voting mechanism).

In some examples, the first value is obtained via the first sensor and a third sensor that is different from the first sensor. In some examples, the first value includes a combination (e.g., a fusion of and/or an average of) of data detected by the first sensor and data detected by the third sensor (e.g., a camera sensor and a lidar sensor, a camera sensor and a radar sensor, a lidar sensor and a radar sensor, a short-range camera sensor and a long-range camera sensor, and/or any combination thereof). In some examples, data generated by the first sensor is a combination of data generated by one sensor and data generated by another sensor.

In some examples, the first sensor is a pair of camera sensors (e.g., a stereo pair and/or a pair of cameras and/or camera sensors that used to identify and/or compute a depth value).

In some examples, while detecting the object that is within the threshold distance from the electronic device and in accordance with a determination that the electronic device is configured to make the first type of decision and the value obtained from data detected by the first sensor is not congruent (e.g., is not equal to, does not translate to an approximation of, and/or is not an approximation of) with the value obtained from data detected by the second sensor, the electronic device selects the respective value (e.g., as the value obtained from data detected by the first sensor or the value obtained from data detected by the second sensor) using a voting mechanism. In some examples, while detecting the object that is within the threshold distance from the electronic device and in accordance with a determination that the electronic device is configured to make the first type of decision and the value obtained from data detected by the first sensor is congruent (e.g., is equal to, translates to an approximation of, and/or approximates) with the value obtained from data detected by the second sensor, the electronic device selects the respective value without using the voting mechanism (e.g., choosing the first value or the second value) (and/or selecting the respective value using sensor fusion).

In some examples, as a part of using the voting mechanism, the electronic device: applies a first weight (e.g., a weight of important, a weight of priority, and/or a voting weight) to select the value obtained from data detected by the first sensor based on an environmental condition (e.g., a weather condition (e.g., raining, snowing, and/or sunny), a road condition (e.g., muddy terrain, gravel terrain, normal road conditions, and/or snow, icy, and/or wet road conditions), traffic conditions (e.g., stop and go traffic or free and clear traffic), daytime, evening, and/or nighttime); and applies a second weight to select the value obtained from data detected by the second sensor based on the environmental condition. In some examples, the first weight is different from (e.g., a different numeral value and/or representation than) the second weight. In some examples, the first weight is based on the sensor type of the first sensor and the environmental condition (e.g., a numerical value (e.g., a value on a scale (e.g., 0 to 1)) that indicates whether or not and/or how well the first sensor performs well or does not perform well in the environmental condition) and the second weight is based on the sensor type of the second sensor (e.g., a numerical value (e.g., a value of the scale) that indicates whether or not and/or how well the second sensor performs well or does not perform well in the environmental condition). In some examples, after applying the first weight (e.g., a weight of important, a weight of priority, and/or a voting weight) to select the value obtained from data detected by the first sensor based on an environmental condition and applying the second weight to select the value obtained from data detected by the second sensor based on the environmental condition, the voting mechanism selects the value obtained from data detected by the first sensor when the total weight(s) applied (e.g., including the first rate) for the value obtained from detected by the first sensor is greater than (or, in some examples) the total weight(s) applied for the value obtained from data detected by the second sensor (or selects the value obtained from data detected by the second sensor when the total weight(s) applied (e.g., including the first rate) for the value obtained from detected by the second sensor is greater than (or, in some examples) the total weight(s) applied for the value obtained from data detected by the first sensor).

In some examples, as a part of using the voting mechanism, the electronic devices: applies a third weight (e.g., a weight of important, a weight of priority, and/or a voting weight) to select the value obtained from data detected by the first sensor based on a determination of quality (e.g., accuracy, dependability, and/or reliability) of previous data detected by the first sensor (e.g., previous data before the object was detected and/or the value obtained by the first sensor or second sensor was detected); and applies a fourth weight to select the value obtained from data detected by the second sensor based on quality of previous data detected by the second sensor. In some examples, the third weight is different from (e.g., a different numeral value and/or representation than) the fourth weight and/or the quality of data detected by the first sensor is different from the quality of previous data detected by the second sensor.

In some examples, in conjunction with (e.g., after, before, and/or while) using the voting mechanism, the electronic device stores (e.g., causing data to be saved and/or stored) data that includes an indication that the voting mechanism was used to select the first value or the second value (and, in some examples, that includes an indication of the value (e.g., first value or second value) that was selected) (e.g., in a database and/or on a cloud server).

In some examples, in accordance with a determination that movement characteristics (e.g., acceleration, direction, velocity, and/or speed) of the electronic device (e.g., and/or (or in some examples, and; or in some examples, or) the object) has a first set of movement characteristics, the threshold distance is a first distance; and in some examples, in accordance with a determination that movement characteristics (e.g., acceleration, direction, velocity, and/or speed) of the electronic device (e.g., and/or (or in some examples, and; or in some examples, or) the object) has a second set of movement characteristics that is different from the first set of movement characteristics, the threshold distance is a second distance that is different from the first distance. In some examples, the threshold distance is dynamic (e.g., determined based on the movement of the electronic device (e.g., in relation to the object) and/or the movement of the object. In some examples, as the electronic device moves towards the object at a faster rate, the threshold distance decreases.

Note that details of the processes described with respect to method 800 (e.g., FIG. 8) are also applicable in an analogous manner to methods 600 and 700. For example, method 800 optionally includes one or more of the characteristics of the various methods described above with reference to method 700. For example, method 800 can be used to determine if a type of decision will be made before using method 700 to determine whether to generate an output using a voting mechanism. The details of all these combinations are not presented here for the sake of brevity.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described to explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A method, comprising:
obtaining, via a first sensor, a first value corresponding to an object;
obtaining, via a second sensor different from the first sensor, a second value corresponding to the object;
in accordance with a determination that the object is classified as having a first level of criticalness, fusing data associated with the first value and data associated with the second value; and
in accordance with a determination that the object is classified as having a second level of criticalness that is different from the first level of criticalness, selecting the first value or the second value.

2. The method of claim 1, wherein:
the first value is generated based on first sensor data that is detected by the first sensor;
the first sensor data is a first type of sensor data;
the second value is generated based on second sensor data that is detected by the second sensor; and
the second sensor data is a second type of sensor data that is different from the first type of sensor data.

3. The method of claim 2, wherein the first type of sensor data has a first resolution, and wherein the second type of sensor data has a second resolution that is different from the first resolution.

4. The method of any one of claims 1-3, wherein the second sensor captures sensor data that is a same type of sensor data that is captured by the first sensor.

5. The method of any one of claims 1-4, wherein:
in accordance with a determination that the object is classified as having the second level of criticalness, the first value or the second value is selected using a voting mechanism.

6. The method of any one of claims 1-5, further comprising:
in conjunction with fusing data associated with the first value and data associated with the second value, storing data that includes an indication that sensor fusion was used.

7. The method of any one of claims 1-6, wherein fusing the data associated with the first value and the data associated with the second value includes averaging a subset of the data associated with the first value with a subset of the data associated with the second value.

8. The method of claim 7, wherein averaging the subset of the data associated with the first value with the subset of the data associated with the second value is performed using an average bias.

9. The method of any one of claims 1-8, wherein the first sensor is a group of a camera sensor, a lidar sensor, a radar sensor, or any combination thereof.

10. The method of any one of claims 1-9, wherein the first value is obtained via the first sensor and a third sensor that is different from the first sensor, and wherein the first value includes a combination of data detected by the first sensor and data detected by the third sensor.

11. The method of any one of claims 1-10, wherein the first sensor is a pair of camera sensors.

12. The method of any one of claims 1-11, further comprising:
before obtaining the first value and the second value, detecting the object using respective data, wherein the determination of whether the object is classified as having the first level of criticalness and the determination of whether the object is classified as having the second level of criticalness are not made using the respective data.

13. The method of any one of claims 1-12, wherein the first level of criticalness of the object is based on at least one characteristic a distance between a respective electronic device and the object, a direction from the respective electronic device to the object, movement of the respective electronic device and/or the object, the type of object, or any combination thereof.

14. The method of any one of claims 1-13, further comprising:
in accordance with a determination that the object is classified as having the second level of criticalness and the first value is not congruent with the second value, performing an action based on the first value or the second value; and
in accordance with a determination that the object is classified as having the first level of criticalness and the first value is not congruent with the second value, forgoing performing the action based on the first value or the second value.

15. A non-transitory computer-readable storage medium storing one or more programs configured to be executed by one or more processors of an electronic device that is in communication with a first sensor and a second sensor different from the first sensor, the one or more programs including instructions for:
obtaining, via the first sensor, a first value corresponding to an object;
obtaining, via the second sensor, a second value corresponding to the object;
in accordance with a determination that the object is classified as having a first level of criticalness, fusing data associated with the first value and data associated with the second value; and
in accordance with a determination that the object is classified as having a second level of criticalness that is different from the first level of criticalness, selecting the first value or the second value.

16. An electronic device, comprising:
a first sensor;
a second sensor that is different from the first sensor;
one or more processors; and
memory storing one or more programs configured to be executed by the one or more processors, the one or more programs including instructions for:
obtaining, via the first sensor, a first value corresponding to an object;
obtaining, via the second sensor, a second value corresponding to the object;
in accordance with a determination that the object is classified as having a first level of criticalness, fusing data associated with the first value and data associated with the second value; and
in accordance with a determination that the object is classified as having a second level of criticalness that is different from the first level of criticalness, selecting the first value or the second value.
